(19) United States
(12) Patent Application Publication
(10) Pub. No.: US 2015/0288236 A1
(43) Pub. Date: Oct. 8, 2015

(54) APPARATUS AND METHODS FOR CONVERTING TORQUE

(71) Applicant: James Patrick Moore, Cambridge (CA)

(72) Inventor: James Patrick Moore, Cambridge (CA)

(21) Appl. No.: 14/529,746

(22) Filed: Oct. 31, 2014

Related U.S. Application Data
(60) Provisional application No. 61/995,060, filed on Apr. 2, 2014.

(51) Int. Cl. H02K 1/34; H02K 1/27; H02K 1/17

(52) U.S. Cl. CPC H02K 1/34; H02K 1/17; H02K 1/27; Y10S 74/09; H02K 53/00

(57) ABSTRACT

A torque converter includes a rotor and a cam follower. The rotor has an eccentric profile defining a power output phase and a reset phase. The rotor includes a magnetic rotor portion, and the cam follower includes a magnetic follower portion attracted to the magnetic rotor portion for biasing the cam follower towards the rotor. The cam follower is configured to reciprocate in response to rotation of the rotor through the power output phase and the reset phase. The torque converter also includes an output mechanism that is selectively engaged with the cam follower during the power output phase and disengaged from the cam follower during the reset phase.

### RELATED APPLICATIONS

This application claims the benefit of U.S. Provisional Patent Application Ser. No. 61/995,060 filed on Apr. 2, 2014, and entitled “Magnetically coupled torque cogenerator II”, the entire contents of which are hereby incorporated by reference herein for all purposes.

### TECHNICAL FIELD

The embodiments disclosed herein relate generally to apparatus and methods for outputting power, and in particular, to apparatus and methods for converting torque into output power using magnetic fields.

### Introduction

Rotors and stators can be used to convert torque and supply electrical or mechanical power using magnetic fields.

U.S. Pat. No. 3,935,487 by Czerniak describes a permanent magnet motor which generates mechanical output power by the repulsion forces between a movable permanent magnet and a fixed permanent magnet. A movable magnetic shield is interposed between the magnets when they are adjacent to one another and then the shield is moved to expose the fixed magnet as the movable magnet passes by. A second fixed magnet can be added to increase the output power by attracting the movable magnet as it approaches. The movable magnetic shield is interposed between the movable magnet and the second fixed magnet when they are adjacent one another.

US20130119674 by Regnault describes a magnet generator that continues in operation non-stop until stopped by the operator with its main source of power being permanent magnets which are axially and diagonally arranged to create a magnetic field when there is an impulse of rotation initiated by the auto-rotation starter device.

EP1501174 by Ogoshi describe a power generator adapted to provide an electrical power greater than an input power by means of a permanent magnet. The power generator comprises a rotatable rotor, a plurality of permanent magnets, and a plurality of coreless coils.

U.S. Pat. No. 4,151,431 by Johnson describes a method of utilizing the unpaired electron spins in ferromagnetic and other materials as a source of magnetic fields for producing power without any electron flow as occurs in normal conductors, and to permanent magnet motors for utilizing this method to produce a power source. In the practice of the invention the unpaired electron spins occurring within permanent magnets are utilized to produce a motive power source solely through the superconducting characteristics of a permanent magnet and the magnetic flux created by the magnets are controlled and concentrated to orient the magnetic forces generated in such a manner to do useful continuous work, such as the displacement of a rotor with respect to a stator.

U.S. Pat. No. 1,724,446 by Worthington describes a means whereby the attraction and repulsion of permanent magnets for each other may be converted into motion, by intermittently introducing a shunt into the magnetic flux of one of a pair of magnets in juxtaposition.

U.S. Pat. No. 1,863,294 by Bogia describes a series of permanent magnets, of the horseshoe type, with the poles of each disposed in radially spaced relation with reference to the axis of the rotor; the poles of the two series being opposed in such spaced relation as to permit the rotor to turn between them; said rotor including two circular series of permanent magnets, of the straight type, extending in parallel relation with the axis of the rotor and in alignment with the opposed poles of the stator magnets. The poles of the horse-shoe magnets are so disposed that the axially aligned poles in the two series are of opposite polarity.

U.S. Pat. No. 3,703,653 by Tracy et al. describes a permanent magnet motor which utilizes pairs of permanent magnets as the power source for the motor. The magnets of each pair are arranged with their like poles adjacent to one another so that normally the magnets of the pairs oppose or repel one another. Shiftable means are provided for being inserted between the magnets of each pair so as to then alter the magnetic field between the magnets to cause the magnets to move toward one another with considerable force. One magnet of each pair is connected to a common drive shaft member. The shiftable means for being inserted between and withdrawn from the magnets of each pair are shifted by any suitable means in timed relationship with one another.

U.S. Pat. No. 3,811,058 by Kiniski describes a device which converts the magnetic force of permanent magnets into reciprocating motion. The reciprocating device comprises at least one cylinder chamber formed in an engine block. The cylinder chamber is open-bottomed. A piston which is made of a magnetic material having a predetermined polarization is slidably disposed in the cylinder chamber. A disc is rotatably mounted to the engine block. The disc has a surface therein movable relative to the open bottom of the cylinder chamber. At least one permanent magnet having a magnetic polarization identical to that of the piston is mounted on the surface of the disc. The disc is rotatable selectively to align the permanent magnet with the piston periodically. The repulsion force between the piston and the permanent magnet causes the piston to reciprocate in the cylinder chamber.

U.S. Pat. No. 3,879,622 by Ecklin describes a permanent magnet motor that utilizes a spring-biased reciprocating magnetizable member positioned between two permanent magnets. Magnetic shields in the form of rotatable shutters are located between each permanent magnet and the reciprocating member to alternately shield and expose the member to the magnetic field thereby producing reciprocating motion. A second embodiment utilizes a pair of reciprocating spring-biased permanent magnets with adjacent like magnetic poles separated by a magnetic shield which alternately exposes and shields the like poles from the repelling forces of their magnetic fields.

U.S. Pat. No. 3,895,245 by Bode describes an electric motor composed of two counter-rotating discs having intermeshing gearing and each carrying a plurality of permanent magnets radially arranged with the same poles at the periphery of both discs. A shield of magnetic material is provided at one side extending partly around the periphery of each of the discs and into substantially the bite of the discs. An electromagnet is arranged with one pole adjacent the bite of the discs, with means to energize the electromagnet as each of the permanent magnets reaches the bite of the discs to create a field of such polarity as to make the magnetic poles of the adjacent permanent magnets move away from the bite of the discs in the direction away from the shield, utilizing the combined forces of the electromagnetic force and the repelling force of the permanent magnets to effect rotation.

U.S. Pat. No. 6,867,514 by Fecera describes a motor providing unidirectional rotational motive power is provided. The motor has a generally circular stator with a stator axis, an outer surface, and a circumferential line of demarcation at about a midpoint of the outer surface. The motor also includes one or more stator magnets attached to the outer surface of the stator. The stator magnets are arranged in a generally circular arrangement about the stator axis and generate a first magnetic field. An armature is attached to the stator for rotation therewith, the armature having an axis parallel to the stator axis. One or more rotors, are spaced from the armature and coupled thereto by an axle for rotation about an axis of each rotor, each rotor rotating in a plane generally aligned with the armature axis. Each rotor includes one or more rotor magnets, with each rotor magnet generating a second magnetic field. The second magnetic field generated by each rotor magnet interacts with the first magnetic field to cause each rotor to rotate about the rotor axis. A linkage assembly drivingly connects each rotor to the stator to cause the armature to rotate about the armature axis thereby providing the unidirectional rotational motive power of the motor.

U.S. Pat. No. 7,400,069 by Kundel describes a generator for producing electric power that includes a drive mechanism, such as a drive motor, having a rotor supported for rotation about an axis. A first generator magnet driveable by the rotor includes a reference pole facing in a first direction. A second generator magnet driveable by the rotor includes a pole of opposite polarity from the reference pole located near the reference pole and facing in the first direction. The first and second generator magnets produce a magnetic field whose flux extends between the reference pole of the first generator magnet and opposite pole of the second generator magnet. A stator includes an electrical conductor winding located adjacent the first and second magnets such that the magnetic field repetitively intersects the winding as the rotor rotates. The drive motor for operating the generator includes a pair of first and second rotor magnets spaced angularly about the axis and supported on the rotor, a reciprocating magnet, and an actuator for moving the first reciprocating magnet cyclically toward and away from the first pair of the rotor magnets, for cyclically rotating the first pair of rotor magnets relative to the reciprocating magnet.

Notwithstanding the above, there is a need for new or improved apparatus and methods for converting torque into output power.

### SUMMARY

According to some embodiments, there is a system for outputting electrical or mechanical power using one or more magnets attached to an indexing member that may either pivot about a central point or move in a linear fashion. The magnets may be attracted to a rotating ferromagnetic member having a decreasing radius component in its geometry. As the ferromagnetic member rotates, the radius presented to the indexing member may decrease. This may draw the magnet attached to the indexing arm, in effect, toward the ferromagnetic member. This attractive force can then be translated through either: a pivot point to a drive gear, through a rack and pinion gear mechanism, or directly to a hydraulic, electrical, or mechanical device utilizing the magnetic attractive force that is developed.

In some embodiments, the rotating ferromagnetic member may have an inherent characteristic or specific section of its circumference at which the magnetic, attractive force is reduced. This reduction in attractive force can be accomplished by geometry, or repulsive magnets of similar polarity, or a diamagnetic material, or a combination thereof.

In some embodiments, the specific section of the ferromagnetic member may cause the index arm to alter its physical position. Furthermore, this specific section may reduce the amount of force and energy needed during a reset cycle as compared to a power cycle wherein the magnets are attracted to the section of the ferromagnetic drum that does not have this reduced, magnetically attractive, characteristic. In some respects, the embodiments herein may be considered a magnetic pump whereby power is developed during a portion of the cycle and the cycle is reset by less energy than that produced as described above.

According to some embodiments, there is a torque converter including a rotor and a cam follower. The rotor has an eccentric profile defining a power output phase and a reset phase. The rotor includes a magnetic rotor portion, and the cam follower includes a magnetic follower portion attracted to the magnetic rotor portion for biasing the cam follower towards the rotor. The cam follower is configured to reciprocate in response to rotation of the rotor through the power output phase and the reset phase. The torque converter also includes an output mechanism that is selectively engaged with the cam follower during the power output phase and disengaged from the cam follower during the reset phase.

The torque converter may include a spacer for separating the magnetic rotor portion from the magnetic follower portion. The spacer may include a wheel coupled to the cam follower for rolling along the eccentric profile of the rotor.

The cam follower may include a linear indexer having a first end portion coupled to the wheel, and a geared rack movable along a longitudinal axis.

The cam follower may include a pivotal indexing arm having a first end portion coupled to the wheel, a second end portion having a drive gear, and a pivot point between the first end portion and the second end portion.

The eccentric profile of the rotor may have a decreasing radius during the power output phase, and an increasing radius during the reset phase. The radius of the rotor may decrease in a linear manner throughout the power output phase. The magnetic rotor portion may include a ferromagnetic drum, and the magnetic follower portion may include at least one follower magnet.

The magnetic rotor portion may be positioned along the rotor for the power output phase, and a reset section may be positioned along the rotor for the reset phase. The magnetic follower portion may include a follower magnet. The reset section of the rotor may have a hollow opening. The reset section of the rotor may include a non-ferromagnetic material. The reset section of the rotor may include a reset magnet with opposite polarity to the follower magnet.

The torque converter may include an input shaft coupled to the rotor for receiving an input torque, and a drive mechanism coupled to the input shaft.

The output mechanism may include a clutch. The clutch may include a clutch bearing that engages a clutch shaft when rotated in one direction and disengages the clutch shaft when rotated in the opposite direction. The output mechanism may include at least one of: an output shaft coupled to the clutch shaft, and a generator coupled to the clutch shaft. The output mechanism may include a flywheel coupled to the clutch shaft.

The output mechanism may include a linear output mechanism.

The output mechanism may include a piezoelectric material.

The torque converter may include a reset assist mechanism for biasing the rotor toward a starting position during the reset phase.

According to some embodiments, there is a method of converting torque. The method includes rotating a rotor having an eccentric profile defining a power output phase and a reset phase. The rotor includes a magnetic rotor portion. The method also includes reciprocating a cam follower in response to rotation of the rotor. The cam follower includes a magnetic follower portion attracted to the magnetic rotor portion for biasing the cam follower towards the rotor. The method also includes selectively engaging an output mechanism with the cam follower during the power output phase, and disengaging the output mechanism from the cam follower during the reset phase.

The magnetic rotor portion may be separated from the magnetic cam portion by a spacer

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a perspective view of a torque converter according to one embodiment;

FIG. 2 is a side elevation view of a ferromagnetic material magnetically attracted to a magnet;

FIG. 3A is a side elevation view of a first magnetic magnetically attracted to a second magnet;

FIG. 3B is a side elevation view of a first magnetic magnetically repelled by a second magnet;

FIG. 4 is a side elevation view of a magnet being separated from a ferromagnetic material;

FIGS. 5A, 5B, and 5C are side elevation views of a magnet being separated from a ferromagnetic material while being inclined at a non-perpendicular angle relative to the ferromagnetic material;

FIGS. 6A, 6B, 6C, and 6D are side elevation views of a magnet being moved parallel to a ferromagnetic surface while maintaining a space therebetween;

FIGS. 7A, 7B, and 7C are side elevation views of a first magnet being moved parallel to a second magnet having opposite polarity while maintaining a space between the magnets;

FIG. 8 is a side elevation view of a wheel for maintaining separation between a magnet and a ferromagnetic material;

FIGS. 9A, 9B, and 9C are side elevation views of the wheel of FIG. 8 rolling along the ferromagnetic material;

FIG. 10 is a side elevation view of the wheel of FIG. 8 rolling along a rotor having an eccentric profile;

FIG. 11 is a schematic side elevation view of the rotor with the eccentric profile;

FIG. 12 is a schematic side elevation view of a power output phase of the torque converter as a cam follower travels along the rotor;

FIG. 13 is a schematic side elevation view of a reset phase of the torque converter as a cam follower travels along the rotor;

FIGS. 14A, 14B, and 14C are perspective views of rotors having alternative types of reset sections according to some embodiments;

FIG. 15 is a perspective view of an elongated rotor having a reset section with a hollow opening according to another embodiment;

FIG. 16 is a perspective view of an elongated rotor having a reset section including a plurality of magnets with similar facing, net-polarity as a magnet of a cam follower according to another embodiment;

FIG. 17 is a perspective view of an elongated cam follower having a lever configuration that pivots back and forth about a pivot point according to another embodiment;

FIG. 18 is a perspective view of a torque converter that includes the elongated rotor of FIG. 16 and the elongated cam follower FIG. 17;

FIGS. 19A, 19B, 19C, 19D, and 19E are side elevation views showing an operational cycle of the torque converter of FIG. 18;

FIG. 20 is a perspective view of a reset assist mechanism for use with the torque converter of FIG. 1;

FIG. 21 is a side elevation view of a reset assist mechanism for use with the torque converter of FIG. 18;

FIG. 22 is a perspective view of a modular system including a plurality of torque converters for operating a generator according to another embodiment;

FIG. 23 is a perspective view of a modular system including a plurality of torque converters for operating a plurality of linear output mechanisms according to another embodiment;

FIG. 24 is a perspective view of a miniature torque converter for operating a piezoelectric material according to another embodiment;

FIG. 25 is a perspective view of a torque converter including a plurality of cam followers arranged around a rotor within a rotating cylinder according to another embodiment;

FIG. 26 is a perspective view of a torque converter including a flexible connection member between the cam follower and a clutch according to another embodiment;

FIG. 27 is a perspective view of a torque converter including a rigid connection member between a cam follower and a clutch according to another embodiment;

FIG. 28 is a top plan view of a torque converter including a plurality cam followers and linear output mechanisms arranged within an outer frame around a rotor according to another embodiment;

FIG. 29 is a side elevation view of the torque converter of FIG. 29 showing the cam followers and the linear output mechanisms arranged in stacked levels;

FIG. 30 is a top plan view of a torque converter including a plurality of linear output mechanisms positioned radially inside a rotor according to another embodiment;

FIG. 31 is a top plan view of a torque converter including inner hydraulic cylinders positioned radially inside a rotor, and outer hydraulic cylinders positioned radially outside the rotor according to another embodiment;

FIG. 32 is a side elevation view of the torque converter of FIG. 31;

FIG. 33 is a top plan view of a torque converter including a plurality of inner hydraulic cylinders and outer hydraulic cylinders positioned around a rotor according to another embodiment;

FIGS. 34A, 34B, 34C, 34D, 34E, 34F, 34G, and 34H are top plan views showing an operational cycle of the torque converter of FIG. 33;

FIG. 35 is a side elevation view of a torque converter that includes a follower magnet parallel to a surface of a ferromagnetic drum according to another embodiment; and

FIG. 36 is a side elevation view of a torque converter that includes a follower magnet tilted backward relative a surface of a ferromagnetic drum according to another embodiment.

### DETAILED DESCRIPTION

In general, the embodiments herein relate to apparatus, systems, and methods for converting torque using magnetism to produce output power such as electrical power, mechanical power, hydraulic power, or pneumatic power. Some embodiments use attractive magnetic forces between a magnet and a ferromagnetic material to develop torque in a cyclic rotational manner to produce output power.

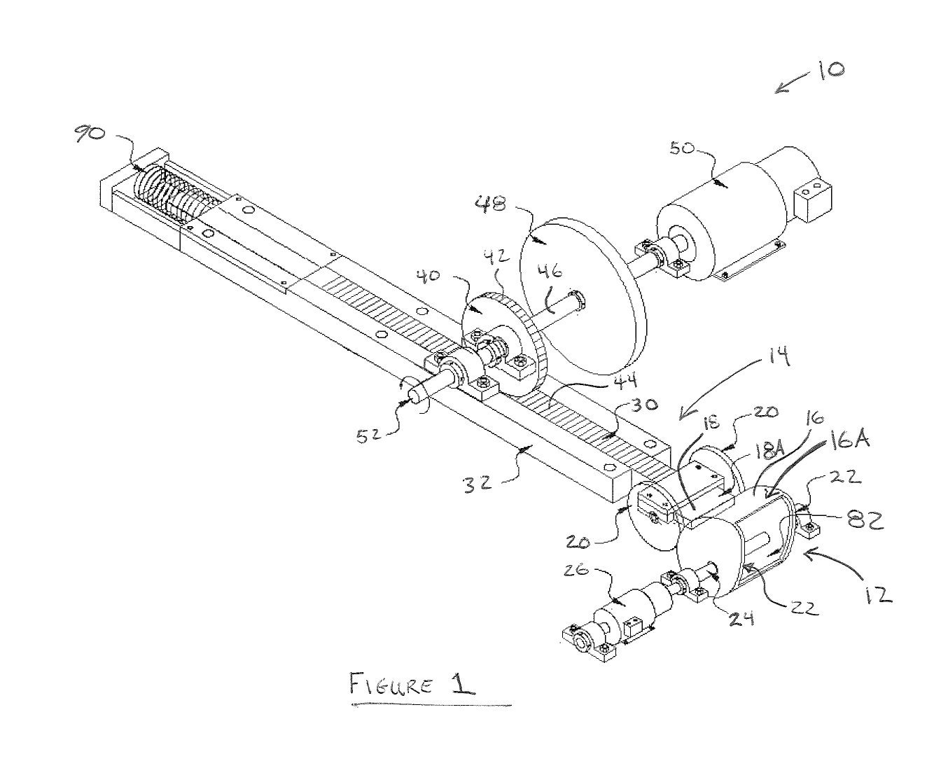

Referring to FIG. 1, illustrated therein is a torque converter 10 including a rotor 12 and a cam follower 14. The rotor 12 can be rotated about an input shaft 24 by a drive mechanism 26 such as an input motor. The rotor 12 has an eccentric profile defining a power output phase and a reset phase. In this example, the rotor 12 has a radius that decreases during the power output phase and increases during the reset phase.

The rotor 12 includes a magnetic rotor portion 16A. The cam follower 14 includes a magnetic follower portion 18A attracted to the magnetic rotor portion 16A for biasing the cam follower 14 towards or against the rotor 12. The magnetic portions 16A and 18A may be combinations of magnets, ferromagnetic materials, or other magnetic materials. For example, in the illustrated example, the magnetic rotor portion 16A includes a ferromagnetic material such as a ferromagnetic drum 16, and the magnetic follower portion 18A includes a magnet 18. The magnet 18 may be a permanent magnet such as a rare earth magnet, an electro-magnet, or another type of magnet. In other embodiments, the magnetic portions could have other configurations. For example, the magnet and ferromagnetic material could be reversed such that the magnetic rotor portion 16A includes a magnet, and the magnetic follower portion 18A includes a ferromagnetic material attracted to the magnet. In other examples, the rotor 12 and the cam follower 14 could both have magnets attracted to each other.

The torque converter 10 may include one or more spacers such as wheels 20 for separating the magnetic rotor portion 16A from the magnetic follower portion 18A. Although there may be significant magnetic attraction between the magnetic rotor portion 16A and the magnetic follower portion 18A, the wheels 20 keep them from touching. The wheels 20 may roll along an outer bearing surface 22 of the rotor 12 during rotation of the rotor 12. The magnetic attractive force between the magnetic rotor portion 16A and the magnetic follower portion 18A press the wheels 20 against the outer bearing surface 22.

While the illustrated embodiment includes a spacer such as the wheel, other embodiments may have other configurations. For example, the magnetic follower portion 18A may have a cylindrical shape configured to roll along the outer bearing surface 22 of the rotor 12.

The cam follower 14 is configured to reciprocate in response to rotation of the rotor 12. For example, in FIG. 1, the cam follower 14 includes an indexing arm 30 (also referred to as a “linear indexer”) attached to the magnetic follower portion 18A and the wheels 20. The indexing arm 30 is contained within an indexer housing 32. The indexing arm 30 moves within the indexer housing 32 along a linear path back and forth relative to the rotor 12 during rotation thereof. More particularly, as the rotor 12 rotates about the input shaft 24, the radius of the rotor 12 changes. For example, during the power output phase the radius of the rotor 12 decreases and the indexing arm 30 moves toward the rotor 12 due to magnetic attraction between magnetic rotor portion 16A and the magnetic follower portion 18A. During the reset phase, the radius of the rotor 12 increases and the indexing arm 30 moves away from the rotor 12.

The drive mechanism 26 may be used to start, stop, or control rotational speed of the rotor 12. The drive mechanism 26 may also act as a safety feature during operation. The drive mechanism 26 may be operated electrically, pneumatically, hydraulically, mechanically, or otherwise.

The torque converter 10 also includes an output mechanism that selectively engages the cam follower 14 during the power output phase and disengages from the cam follower 14 during the reset phase. In some embodiments, the output mechanism may include a clutch 40. As shown, the clutch 40 includes a clutch gear 42 that meshes with, or otherwise engages, a rack gear 44 located along the indexing arm 30. The clutch gear 42 may be coupled to a clutch bearing that engages a clutch shaft 46 when rotated in one direction and disengages the clutch shaft 46 when rotated in the opposite direction.

In operation, the magnetic attraction and resultant movement of the cam follower 14 are transferred to the clutch 40. This can produce an output torque through the clutch shaft 46. For example, in the illustrated example, during the power output phase, the rack gear 44 moves towards the rotor 12 and the clutch gear 42 rotates counter-clockwise while engaged with the clutch shaft 46 to output power and torque. During the reset phase, the rack gear 44 moves away from the rotor 12 and the clutch gear 42 rotates clockwise while disengaged from the clutch shaft 46. No power or torque are output during the reset phase.

Over time, output torque can produce an output power that can be utilized to rotate an electric generator 50, a mechanical output shaft 52, or another device. In some embodiments, a flywheel 48 may be coupled to the clutch shaft 46 (e.g. between the clutch 40 and the generator 50 or output shaft 52). The flywheel 48 may help reduce spikes or fluctuations in the output power.

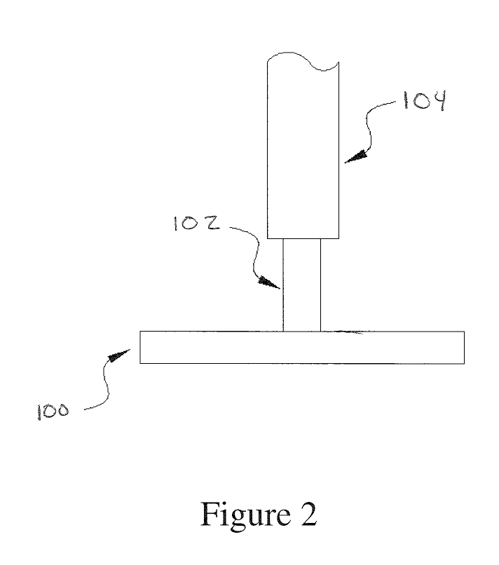

Referring now to FIGS. 2-7, a theoretical basis for the torque converter and other embodiments herein will now be described.

With reference to FIG. 2, illustrated therein is a ferromagnetic material 100, and a magnet 102 attached to an indexing arm 104. The magnet 102 is attracted to the ferromagnetic material 100. The magnetic attractive force is generally at a maximum when the magnet 102 comes into contact with the ferromagnetic material 100.

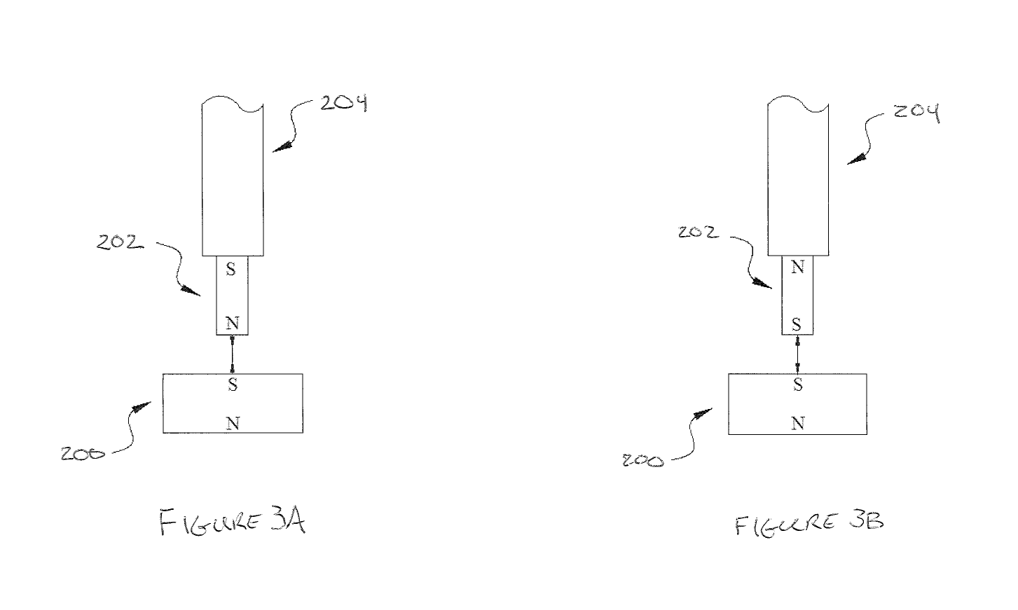

With reference to FIGS. 3A and 3B, illustrated therein is a first magnet 200, and a second magnet 202 attached to an indexing arm 204. In FIG. 3A, the first magnet 200 and is attracted to the second magnet 202 because the polarities are opposite. In FIG. 3B, the first magnet 200 and is repelled by the second magnet 202 because the polarities are the same. In both situations, the strength of the magnetic force tends to be a function of distance between the magnets 200 and 202. For example, the force of attraction/repulsion tends to increase as the magnets 200 and 202 come closer together. The force tends to be at a maximum when the magnets 200 and 202 are in direct contact with one another.

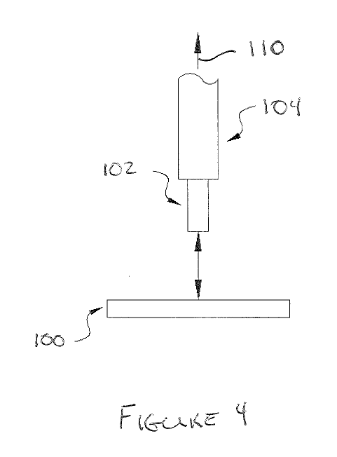

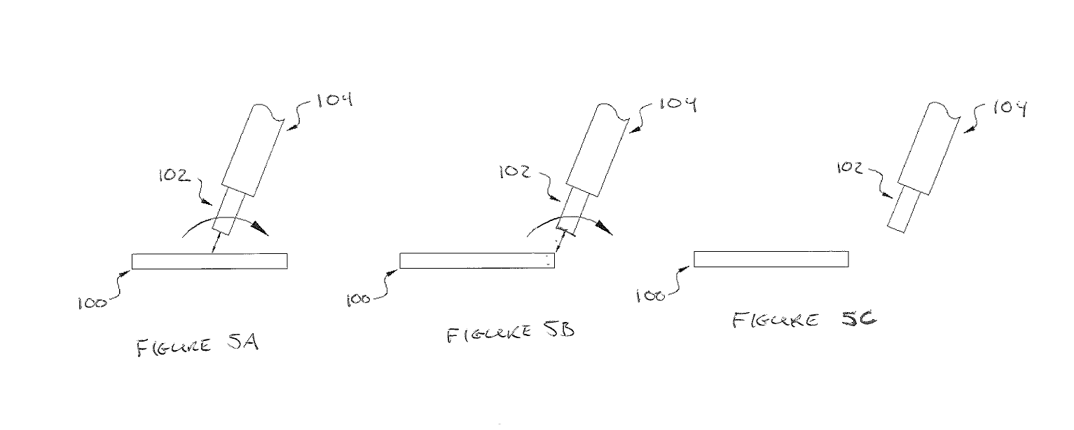

In the field of mathematical geometry, the orientation (angular position, or attitude) of an object is part of the description of how it is placed in the space it occupies. It is a property of magnets that when two net resultant magnetic fields approach a perpendicular angular orientation relative to each other, the forces of magnetic attraction and/or repulsion tend to approach a maximum (e.g. as described above in FIGS. 2 and 3). For example, a separating force (indicated by arrow 110 in FIG. 4) applied to the magnet 102 and indexing arm 104 perpendicular to the surface of the ferromagnetic material 100 tends to be highest when the magnet 102 is in contact with the ferromagnetic material 100. As the magnet 102 begins to move away from the ferromagnetic material 100, the separating force tends to decrease or grow weaker. With reference to FIGS. 5A-5C, shifts in angle away from perpendicular may also reduce the force involved with separating the magnet 102 from the ferromagnetic material 100. For example, as shown, the magnet 102 may be inclined at a non-perpendicular angle relative to the ferromagnetic material 100.

The principles above also tend to apply to two magnets having a net force of attraction. For example separating two magnets that are inclined at a non-perpendicular angle tends to involve less force than when using a perpendicular separating force. Note that perpendicular orientation includes 3-dimensional geometric orientations.

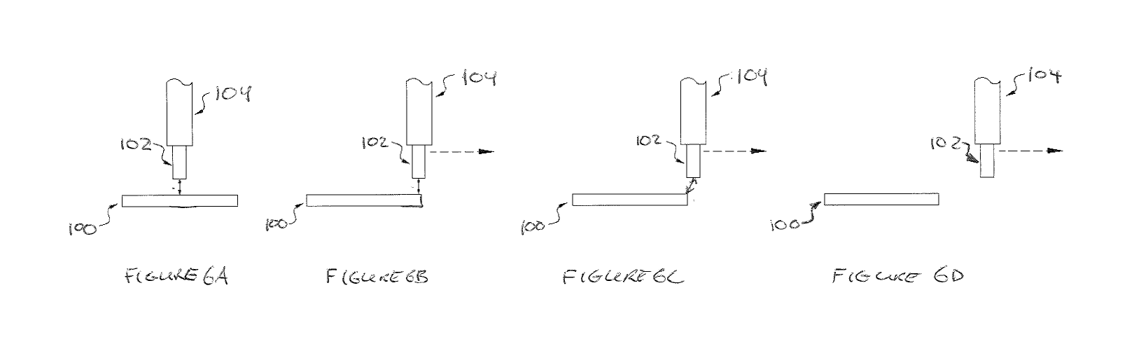

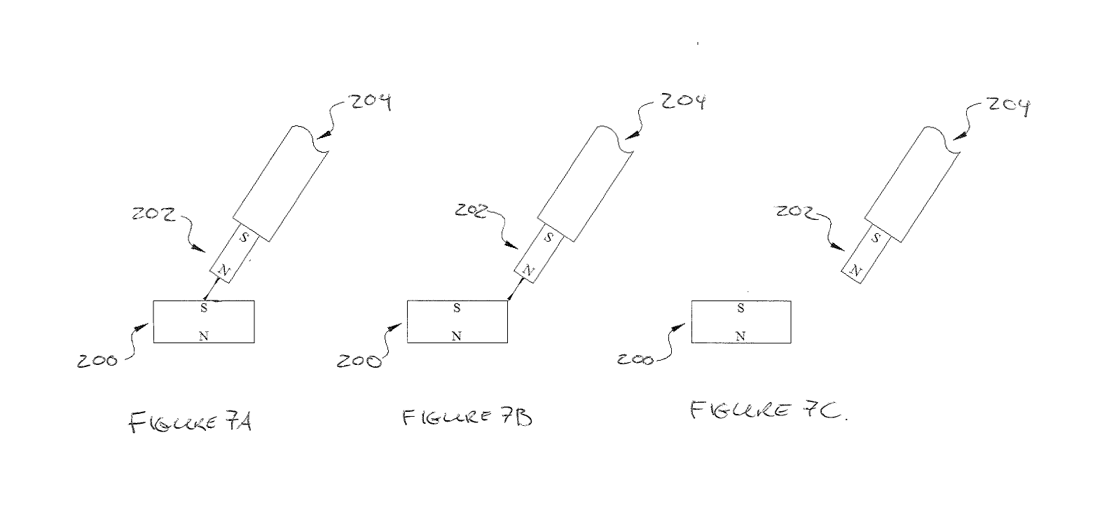

With reference to FIGS. 6A-6B, when moving the magnet 102 above the ferromagnetic material 100 (e.g. parallel to the surface of the ferromagnetic material), there tends to be no surface friction. Accordingly, a small or negligible amount of energy may be used to move the magnet 102 above the ferromagnetic material 100. However, as the magnet 102 approaches the edge of the ferromagnetic material 100 (e.g. as in FIG. 6C), the change in the magnetic field geometry results in a resistance to further movement of the magnet 102 away from the ferromagnetic material 100. This resistance may be referred to as a “magnetic impingement”. If additional force is applied to overcome the magnetic impingement, the magnet 102 can be moved further away (e.g. as in FIG. 6D), and the force of magnetic attraction tends to diminish.

FIGS. 7A-7C illustrate the change in magnetic attractive force between two magnets 200 and 202 having relative opposite polarities. As shown, inclining one magnet 202 away from a perpendicular orientation tends to reduce the force involved with separating the magnets 200 and 202. Furthermore, when moving the magnet 202 above the other magnet 200 there tends to be a point of magnetic impingement at the edge of the magnet 200 (e.g. as shown in FIG. 7B). With sufficient force, the magnets 200 and 202 can be separated and the force of magnetic attraction tends to diminish.

Given these properties, a power cycle can be created that takes advantage of a relatively strong force of attraction/repulsion during a power output phase. Furthermore, in accordance with some embodiments herein, the power cycle may be followed by a reset phase involving a relatively weaker magnetic force of attraction or magnetic repulsion, which may be a result of changes in orientation, polarities, material properties, or some combination thereof.

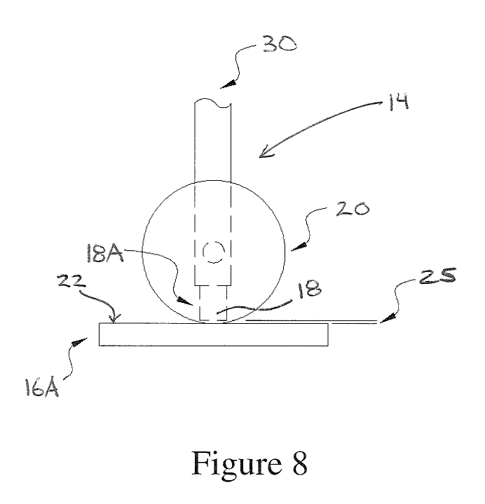

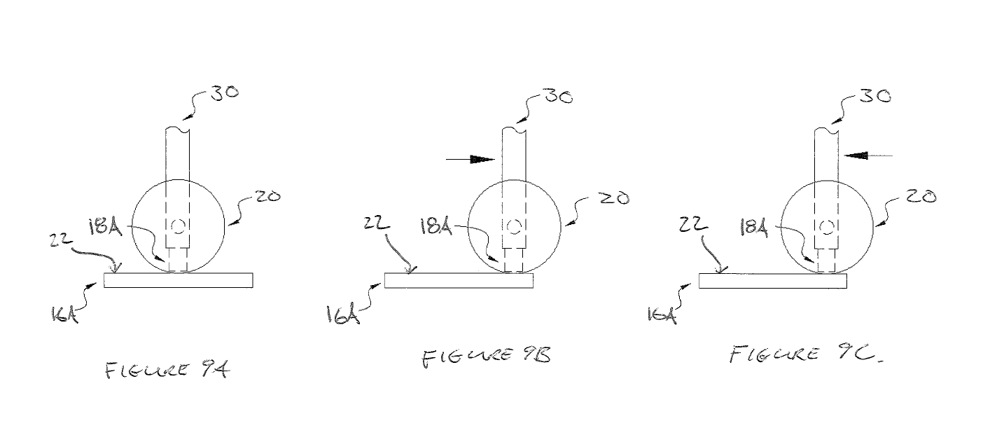

Referring now to FIG. 8, the magnetic follower portion 18A (e.g. the follower magnet 18) is separated from the magnetic rotor portion 16A (e.g. the ferromagnetic drum 16) by a spacer such as a wheel 20. For example, the wheel 20 may separate the follower magnet 18 from the ferromagnetic drum 16 by a spacer distance 25. Furthermore, with reference to FIGS. 9A-9C, a small amount of input energy may be used to roll the wheel 20 along the outer bearing surface 22. In this case, the input force may overcome the friction inherent to the wheel 20. Without the wheel 20 (or another type of spacer), the magnetic follower portion 18A might become attached to the magnetic rotor portion 16A and more energy would be needed to move the magnetic follower portion 18A along the magnetic rotor portion 16A.

When using the wheel 20, the force used to roll the magnetic follower portion 18A across the magnetic rotor portion 16A is generally less than the force of magnetic attraction between the magnetic rotor portion 16A and the magnetic follower portion 18A. In some examples, the magnetic attraction could be equivalent to a 100-lb force, and the force to roll the magnetic follower portion 18A across the magnetic rotor portion 16A using the wheel 20 could be equivalent to a 5-lb force.

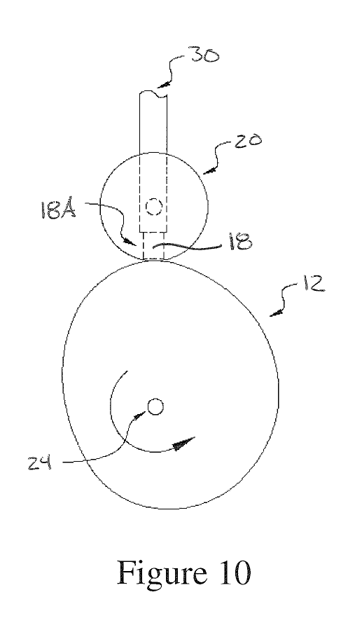

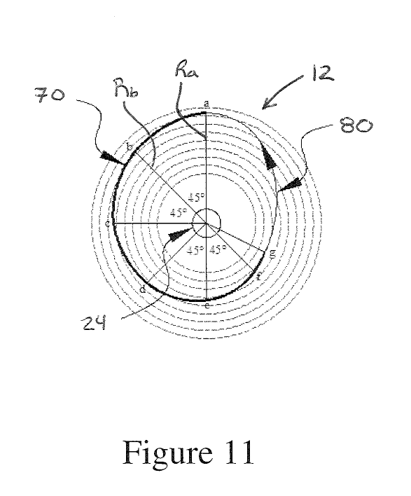

Referring now to FIGS. 10 and 11, the shape of the rotor 12 will be described in further detail. As shown, the rotor 12 rotates about the input shaft 24. In FIG. 11, the power output phase is represented by reference numeral 70, and the reset phase is represented by reference numeral 80.

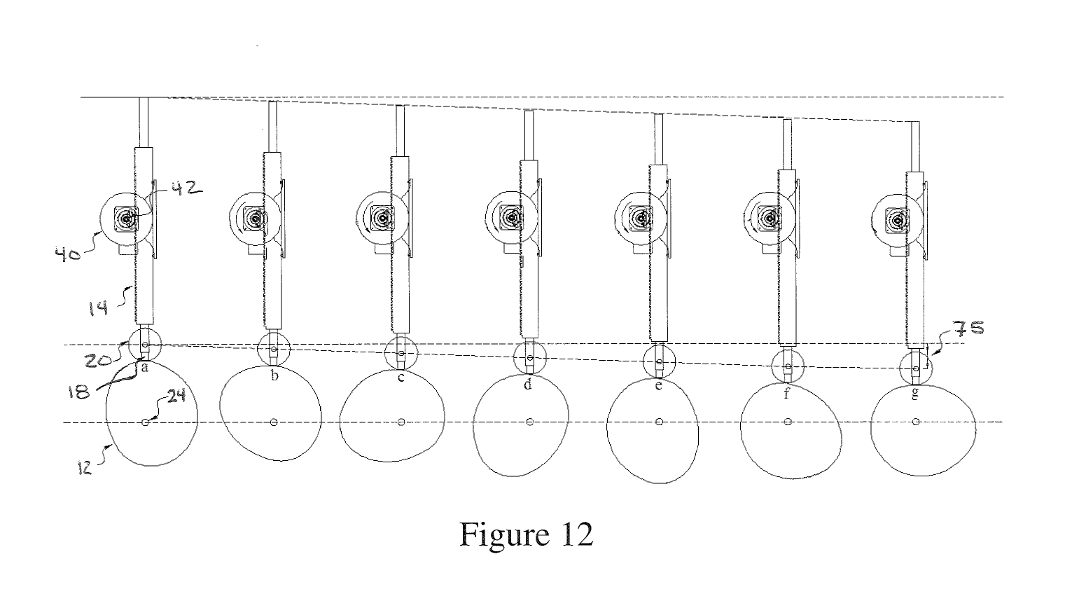

In operation, as the rotor 12 rotates through the power output phase 70, the cam follower 14 is drawn toward the center of the rotor 12 and power output (e.g. through the clutch 40). As shown in FIG. 12, the power output phase 70 occurs between points “a” and “g”. At point “g” the cam follower 14 stops moving toward the rotor 12 (e.g. in a similar manner as a piston will stop at top dead center in a reciprocating combustion engine during a combustion cycle). It is noted, that point “g” represents a transition between the power output phase and the reset phase. As the rotor 12 continues to rotate past point “g”, the cam follower 14 is driven back to a starting position at point “a”.

During the power output phase 70, the radius of the rotor 12 may decrease in a linear manner from point “a” to point “f”. That is, for every degree of rotation there is a unit reduction in radius. For example, starting at position “a”, the radius is Rₐ. At position “b”, the radius R_{b} is equal to: R_{b}=Rₐ−ΔR, where ΔR is a constant equal to the distance between concentric circles in FIG. 11. In other words, the rate of change of the radius may remain constant so that the total radial change 75 during the power output phase 70 has a constant rate of change.

The rotor 12 and cam follower 14 can also provide a mechanical advantage. For example, the total radial change 75 from point “a” to point “f” may be considered similar to an inclined ramp for raising an object having a mass “m”. Normally, when lifting the mass “m” vertically without an inclined ramp, a lifting force of mass “m” multiplied by the gravitational constant “g” is used. In contrast, when using a ramp, a reduced lifting force is used based upon inclination of the ramp. For example, if the ramp is 10-feet long and 1-foot high, a lifting force of approximately 10-lb in used to push a 100-lb mass up the ramp (assuming there is negligible friction). The cam follower 14 may provide similar benefits as an inclined ramp based on the total radial change 75 from point “a” to point “g”.

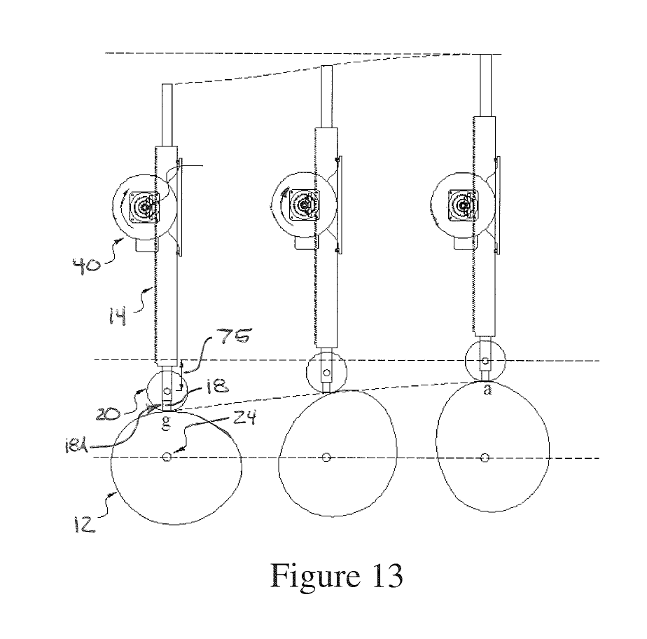

With reference to FIG. 13, during the reset phase 80, the radius of the rotor 12 may increase in a linear manner from point “g” to point “a”. In other words, the rate of change of the radius may remain constant so that the total radial change 75 during the reset phase 80 has a constant rate of change.

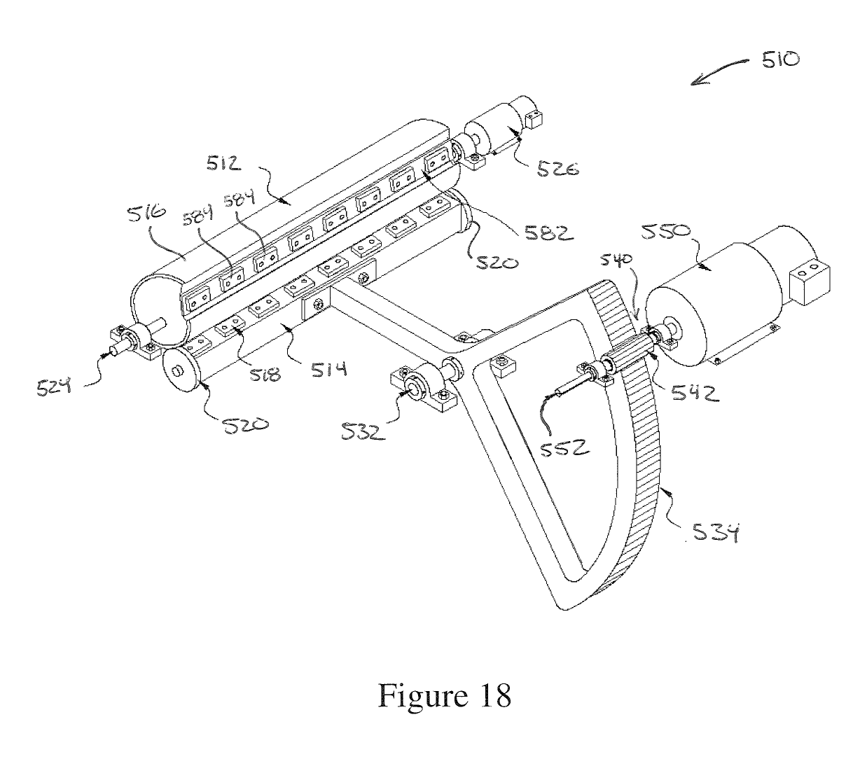

In other embodiments, the rotor 12 may have other shapes such as a non-linear power output phase 70 and/or a non-linear reset phase 80 (e.g. as shown in FIGS. 18, 23, and 24).

The cycle of the torque converter 10 may be considered similar to a hydraulic pump that outputs power (e.g. flow at a pressure over a unit of time during a portion of a physical stroke followed by a mechanism that resets the pump). For this reason, the torque converter 10 may be referred to as a “magnetic pump” because the torque converter 10 takes advantage of magnetic attractive forces during the power output phase followed by a reset phase.

During the reset phase 80 from point “g” to point “a”, there may be a reduced attractive force between the rotor 12 and cam follower 14. It is believed that this configuration may reduce the amount of force or energy involved with rotating the rotor 12 from point “g” back to point “a”. For example, the magnetic follower portion 18A may be repelled or pushed away from the magnetic rotor portion 16A.

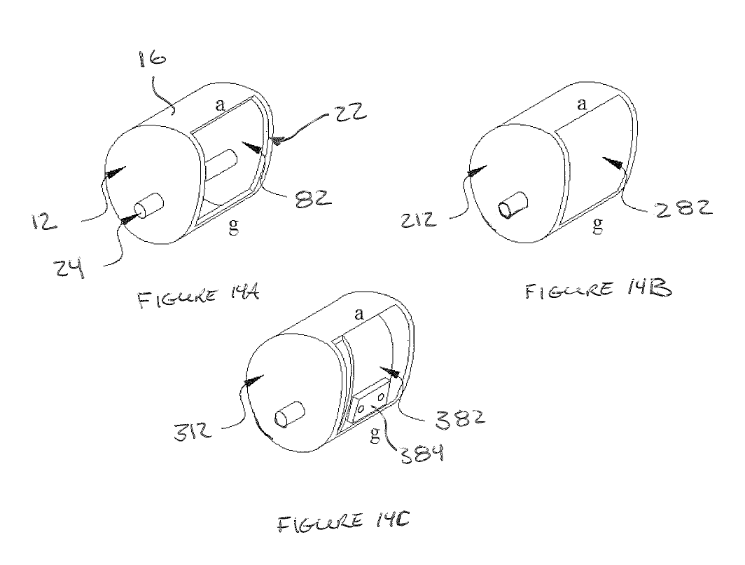

Referring now to FIG. 14A, there is shown a 3-dimensional representation of the rotor 12. As shown, the reset phase 80 corresponds to a reset section 82 located between point “g” and point “a”. The reset section 82 may be designed to reduce or minimize the amount of reset energy to rotate the rotor 12 from point “g” back to point “a”. For example, as shown, the reset section 82 may have a hollow opening and the rest of the rotor 12 may be made from a ferromagnetic material (e.g. the ferromagnetic drum 16). In this case, there would be a reduced degree of magnetic attraction as the follower magnet 18 passes over the reset section 82. In this example, the outer edges of the rotor 12 are solid material and represent the outer bearing surface 22 upon which the wheels 20 can roll.

With reference to FIG. 14B, in another embodiment, there is a rotor 212 with a reset section 282 filled with non-ferromagnetic material. With reference to FIG. 14C, in yet another embodiment there is a rotor 312 with a reset section 382 including one or more reset magnets 384 having a similar facing, net-polarity(s) as the follower magnet 18. The reset section 382 may also include non-ferromagnetic material and/or diamagnetic material. This reduces the energy involved with rotating the rotor from point “g” to point “a”.

In some embodiments, the geometry of the reset section may be designed to minimize or reduce the amount of reset energy involved with rotating the rotor from point “g” to point “a”.

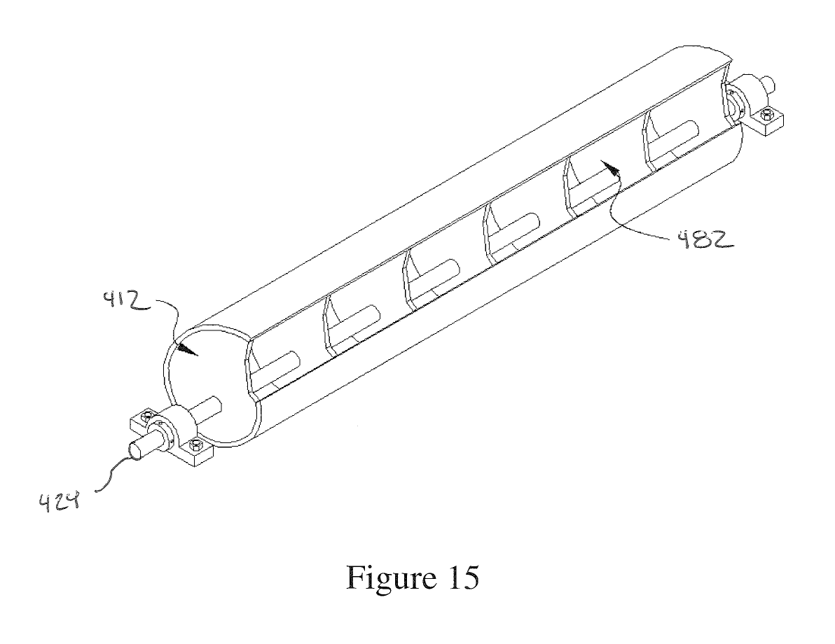

Referring now to FIG. 15, there is shown another embodiment including a rotor 412 rotatable about a shaft 424. The rotor 412 is similar in some respects to the rotor 12 described above. For example, the rotor 412 includes a reset section 482 having a hollow opening. One difference is that the rotor 412 extends longitudinally along the shaft 424, and may be referred to as an “elongated rotor”.

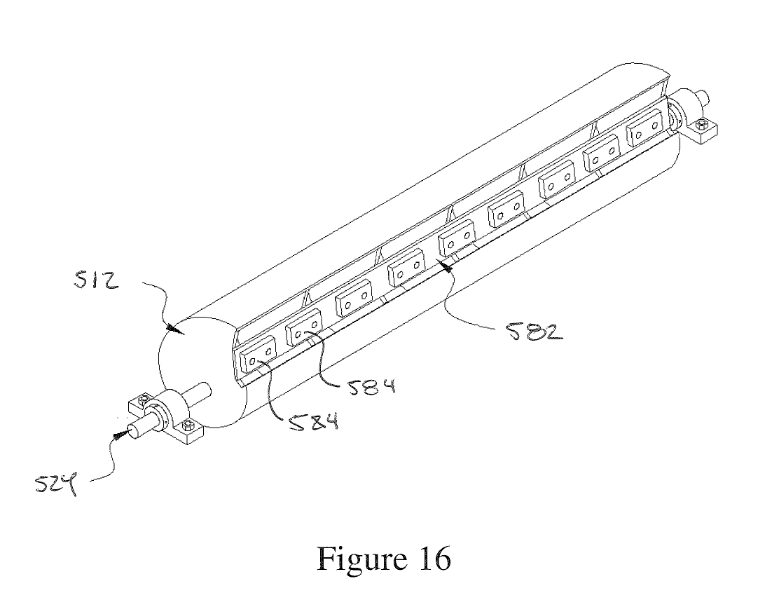

Referring now to FIG. 16, there is shown another embodiment including an elongated rotor 512 rotatable about an input shaft 524. The rotor 512 is similar in some respects to the rotor 412 described above. For example, the rotor 512 includes a reset section 582. The reset section 582 includes a plurality of magnets 522 having a similar facing, net-polarity(s) as a follower magnet of a cam follower (not shown). In some embodiments, the reset section could include a non-ferromagnetic material and/or diamagnetic material.

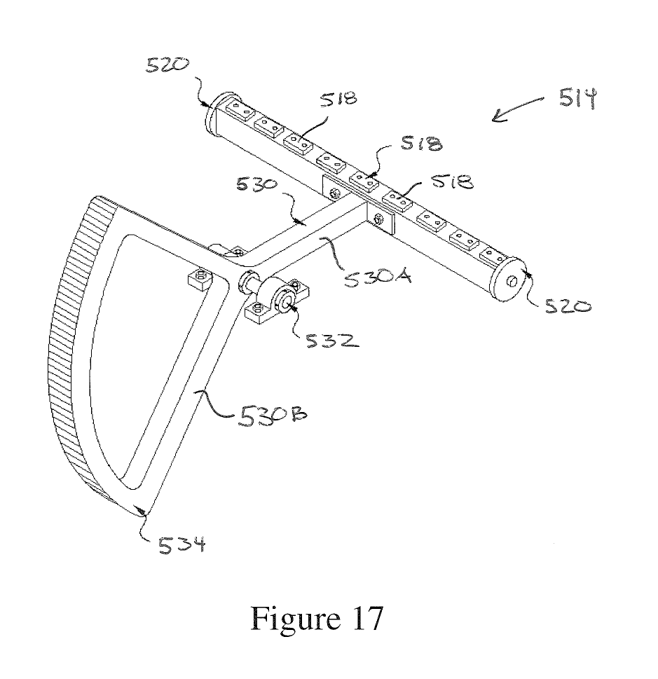

Referring now to FIG. 17, there is shown a cam follower 514 according to another embodiment. The cam follower 514 is similar in some respects to the cam follower 14 described above. One difference is that the cam follower 514 is extended longitudinally, and may be referred to as an “elongated cam follower”. The elongated cam follower 514 includes a plurality of follower magnets 518 that define a magnetic follower portion. A spacer such as wheels 520 is coupled to the cam follower 514 for separating the follower magnets 518 from a corresponding magnetic rotor portion of a rotor (not shown).

In this embodiment, the cam follower 514 has a lever configuration and includes a pivotal indexing arm 530 configured to pivot back and forth about a pivot point 532. The pivotal indexing arm 530 includes an input arm 530A and an output arm 530B. The input arm 530A extends from the pivot point 532 to a first end portion with the wheels 520 and follower magnets 518 coupled thereto. The output arm 530B extends from the pivot point 532 to an second end portion with an arcuate drive gear 534 coupled thereto. As shown, the output arm 530B may have a generally triangular shape. Energy transmitted to the cam follower 514 is transmitted through the pivot point 532 to the arcuate drive gear 534. As shown, the pivot point 532 may be located between the follower magnets 518 and the arcuate drive gear 534, and accordingly, may be referred to as a “central pivot”.

With the lever configuration, it is possible to adjust power output characteristics by changing input arm length (e.g. between the wheels 520 and pivot point 532), or output arm length (e.g. between the pivot point 532 and the drive gear 534). Adjusting the input and output arm lengths may increase or decrease torque and rotational speed at the drive gear 534, which may be helpful when trying to achieve certain power output characteristics.

Referring now to FIG. 18, there is shown a torque converter 510 including the rotor 512 and the cam follower 514. The rotor 512 can be rotated about an input shaft 524 by a drive mechanism 526. Rotation of the rotor 512 causes the cam follower 514 to reciprocate up and down about the pivot point 532. For example, during a power output phase, the cam follower 514 pivots upward towards the rotor 512 due to magnetic attraction between the follower magnets 518 and magnetic rotor portion (e.g. a ferromagnetic drum 516). During a reset phase, the cam follower 514 pivots downward away from the rotor 512. One or more rotor magnets 584 having similar polarity as the follower magnets 518 may magnetically repel the cam follower 514 to assist with the reset phase. The reciprocating pivoting motion of the cam follower 514 is transferred through the pivot point 532 to the drive gear 534. A clutch 540 having a clutch gear 542 selectively engages or meshes with the drive gear 534 to output torque to a generator 550 and/or output shaft 552. For example, the clutch gear 542 may engage the output shaft 552 in one direction during the power output phase. During the reset phase, a clutch bearing in the clutch gear 542 may release or disengage from the output shaft 552 and the clutch gear 542 may spin freely to allow the reset phase to be completed.

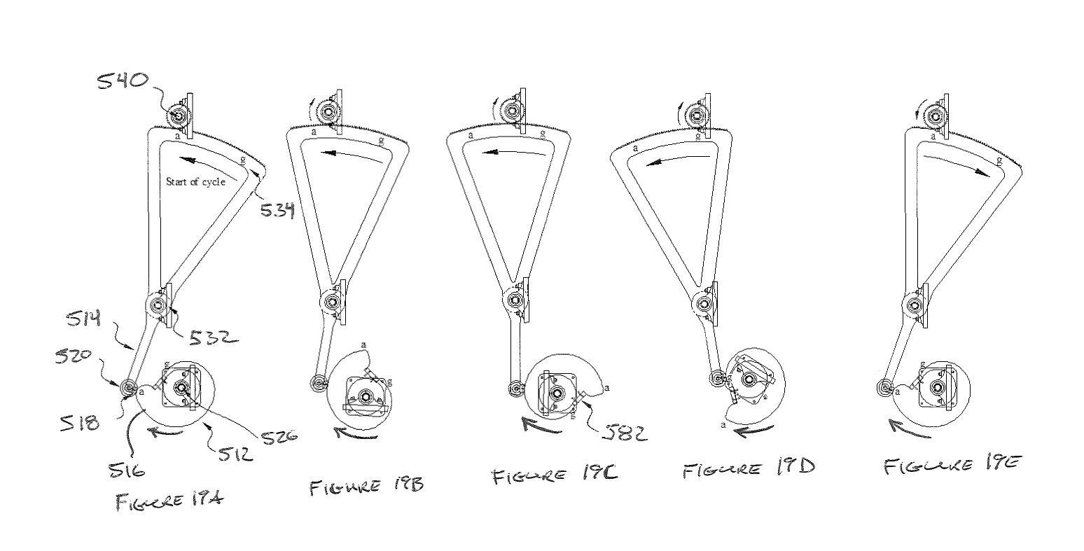

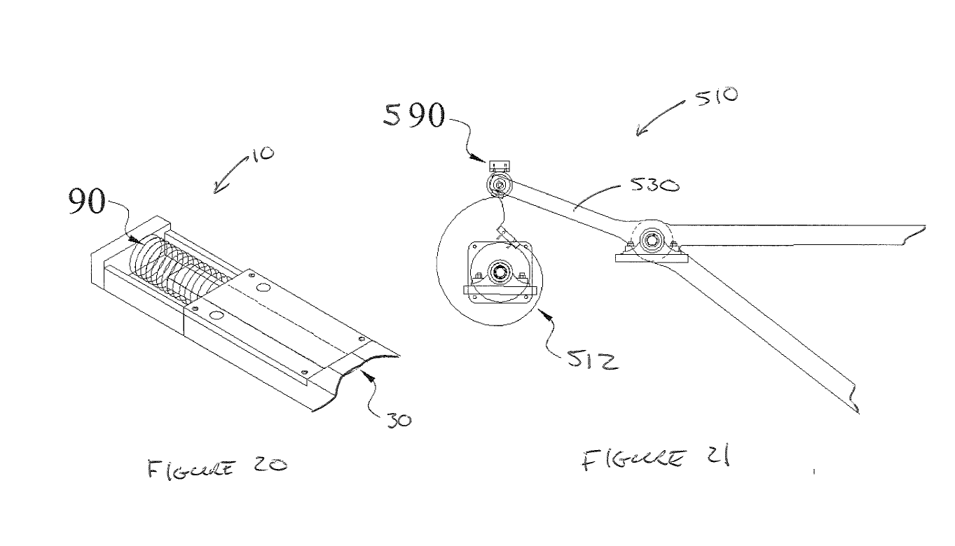

With reference to FIGS. 19A-19E, an operational cycle of the torque converter 510 will be described. Beginning at point “a” in FIG. 19A, there is a force of magnetic attraction between the follower magnets 518 and the ferromagnetic drum 516. The wheels 520 separate the follower magnets 518 from the ferromagnetic drum 516.

During a power output phase, the rotor 512 is rotated clockwise using the drive mechanism 526 from point “a” (shown in FIG. 19A) through to point “g” (shown in FIG. 19D). The force of attraction between the follower magnets 518 and the ferromagnetic drum 516 produces output torque at the drive gear 534. For example, if the force of attraction is a 100-lb force and the distance between the force of attraction and the pivot point 532 is 12-inches, there may be a resultant 100-ft.lb torque available about pivot point 532. If the drive gear 534 at the end of the pivotal indexing arm 530 is 12-inches from the pivot point 532, the output torque at the end of the drive gear 534 would be 100-ft.lb. Alternatively, if the drive gear 534 at the end of the pivotal indexing arm 530 is 24-inches from the pivot point 532, the output torque would be 50-ft.lb at the drive gear 534.

As shown in FIGS. 19A-19D, the drive gear 534 may pivot along a first direction (e.g. counter-clockwise) during the power output phase from point “a” to point “g”. When the follower magnets 518 approach point “g” on the rotor 512, the reset phase of the cycle begins and the follower magnets 518 travel along the reset section 582 until returning to point “a”. During the reset phase of the cycle as shown in FIG. 19E, the drive gear 534 reverses and pivots along a second direction (e.g. clockwise).

In some embodiments, the clutch 540 may be configured to transmit torque to the generator 550 or output shaft 552 in one direction (e.g. during the power output phase of the cycle). The clutch 540 may spin freely when reversed in the other direction (e.g. during the rest phase of the cycle). This allows the torque converter 510 to selectively output power to the generator 550 and/or output shaft 552.

In some embodiments, the torque converter 510 may output power to another device such as a hydraulic system. In such embodiments, the output mechanism may include a relief valve that operates during the reset phase of the cycle. In this sense, the system may operate in a cycle like a magnetic pump (e.g. similar to a hand-driven water pump that pulls water from a well with a reset mechanism that resets the pump to a starting position in order to start another pump cycle).

Referring again to FIG. 1, the cam follower 14 may have a linear output via the indexing arm 30 and indexer housing 32. In this embodiment, increasing the RPM of the drive mechanism 26 tends to increase RPM of the rotor 12, and consequently, the indexing arm 30 moves back and forth at increasing speed. This can increase output power.

Referring now to FIG. 20, the torque converter 10 may include a reset assist mechanism 90 or backstop such as a compression spring that biases the indexing arm 30 towards a starting position (e.g. point “a” of the rotor 12) during the reset phase. Referring to FIG. 21, the torque converter 510 may also include a reset assist mechanism 590 for biasing the pivotal indexing arm 530 and rotor 512 towards a starting position during the reset phase. In some embodiments, the reset assist mechanism may include one or more springs, magnets, or other materials.

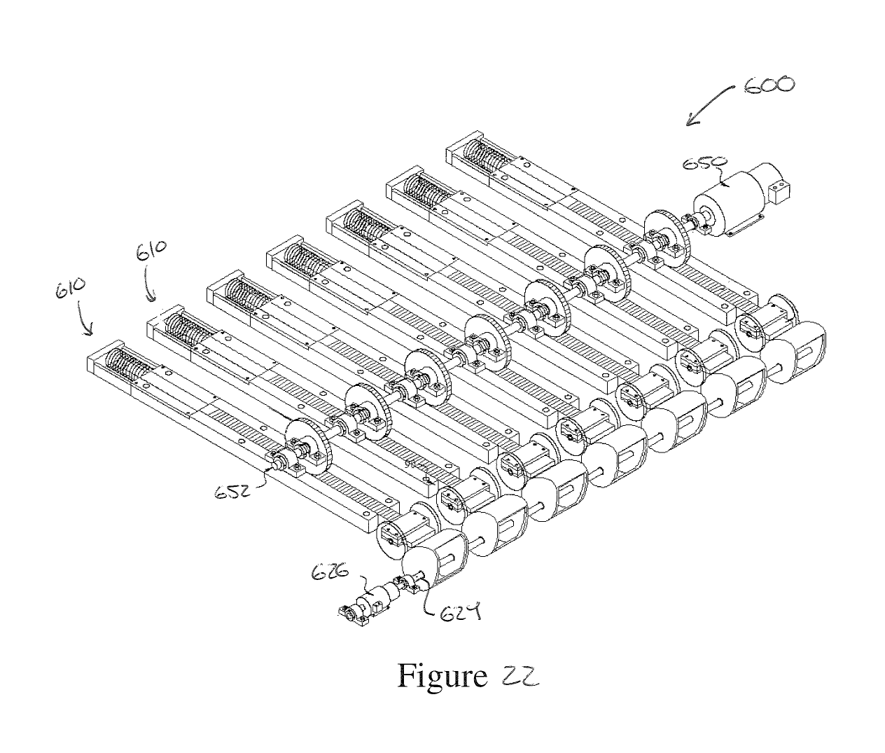

Referring now to FIG. 22, illustrated therein is a system 600 including a plurality of torque converters 610 driven by an input shaft 624 that is rotated by a drive mechanism 626. Each torque converter 610 may be similar to the torque converter 10 and may be configured as a modular section coupled to the input shaft 624. The output from each torque converter 610 is coupled to an output shaft 652 and may be used to operate a generator 650. This modular system 600 may allow for customized power generation, and/or simple fabrication and assembly.

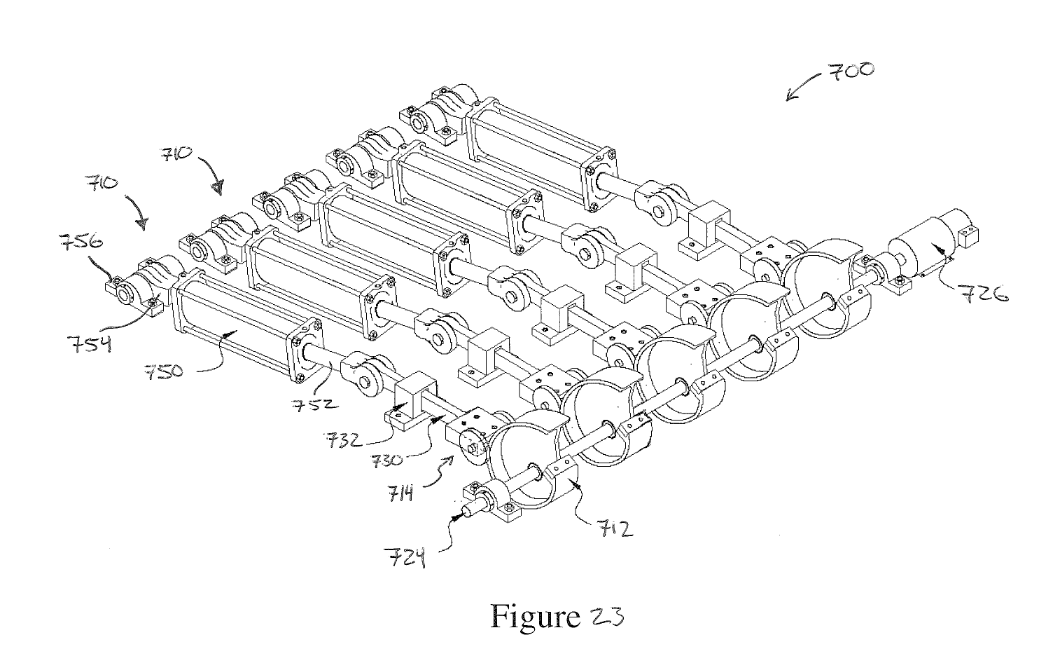

Referring now to FIG. 23, illustrated therein is a system 700 including a plurality of torque converters 710 driven by an input shaft 724 that is rotated by a drive mechanism 726. Each torque converter 710 is configured as a modular section coupled to the input shaft 724. Furthermore, each torque converter 710 includes a rotor 712 and a cam follower 714 that are magnetically attracted to each other. Each cam follower 714 includes an indexing arm 730 that reciprocates back and forth through a guide block 732.

In this embodiment, the torque converter 710 includes an output mechanism in the form of a plurality of linear output mechanisms such as hydraulic cylinders 750 (also referred to as “hydraulic pistons”). Each hydraulic cylinder 750 has a first end 752 pivotally coupled to the indexing arm 730, and a second end 754 pivotally coupled to a base 756. During the power output phase, fluid is pumped through the hydraulic cylinder 750 (e.g. to store or output hydraulic power or energy). During the reset phase, one or more pressure relief valves may be activated, which may introduce new fluid that will be pumped during the next power output phase. In other embodiments, the linear output mechanisms may have other configurations such as one or more linear electric generators, which may have one or more circuits for selectively connecting the cam follower to the linear electric generator during the power output phase, and selectively disconnecting the cam follower from the linear electric generator during the reset phase. In some embodiments, the linear output mechanism could be hydraulic, pneumatic, electric, or mechanical.

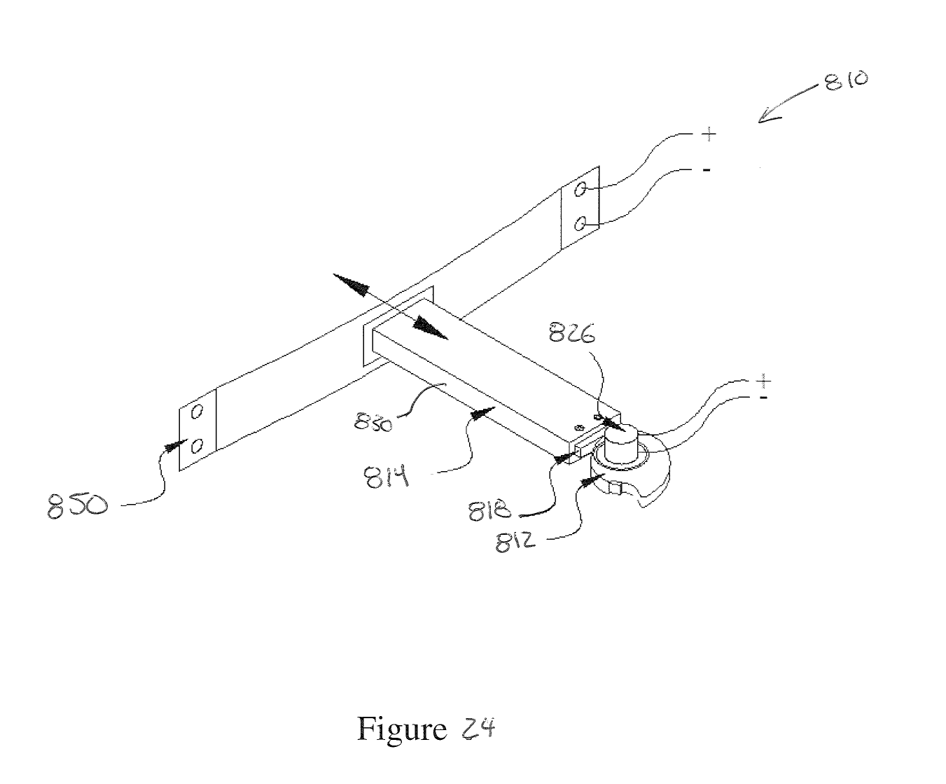

Referring now to FIG. 24, illustrated therein is a miniature torque converter 810 including a rotor 812 rotated by a drive mechanism 826, and a cam follower 814 having a magnet 818 for biasing the cam follower against the rotor 812.

In this embodiment, the torque converter 810 includes an output mechanism in the form of a piezoelectric material 850. The cam follower 814 includes an indexing arm 830 coupled to the piezoelectric material 850. Reciprocating movement of the indexing arm 830 back and forth flexes or otherwise distorts the piezoelectric material 850 to produce electrical output power in the form of a corresponding voltage and current. The electrical output power may be supplied to an electrical load. For example, the torque converter 810 may be capable of operating small electronic devices such as cell phones, tablets, computers, heated clothing, or other low-power electrical devices. While the miniature torque converter 810 is capable of operating electrical devices, other embodiments may include miniature torque converters capable of operating mechanical devices such as miniature gears, hydraulics, valves, and the like.

Referring to FIG. 25, illustrated therein is a torque converter 910 including a rotor 912 and a plurality of cam followers 914 magnetically attracted to the rotor 912. As shown, the cam followers 914 are arranged around the rotor 912 and are positioned within a rotating cylinder 950. Each cam follower 914 is coupled to a clutch 940 for selectively transmitting power to the rotating cylinder 950. This embodiment may provide one or more benefits such as decreased space requirements, multiple and simultaneous power cycles, or redundancy for improved reliability.

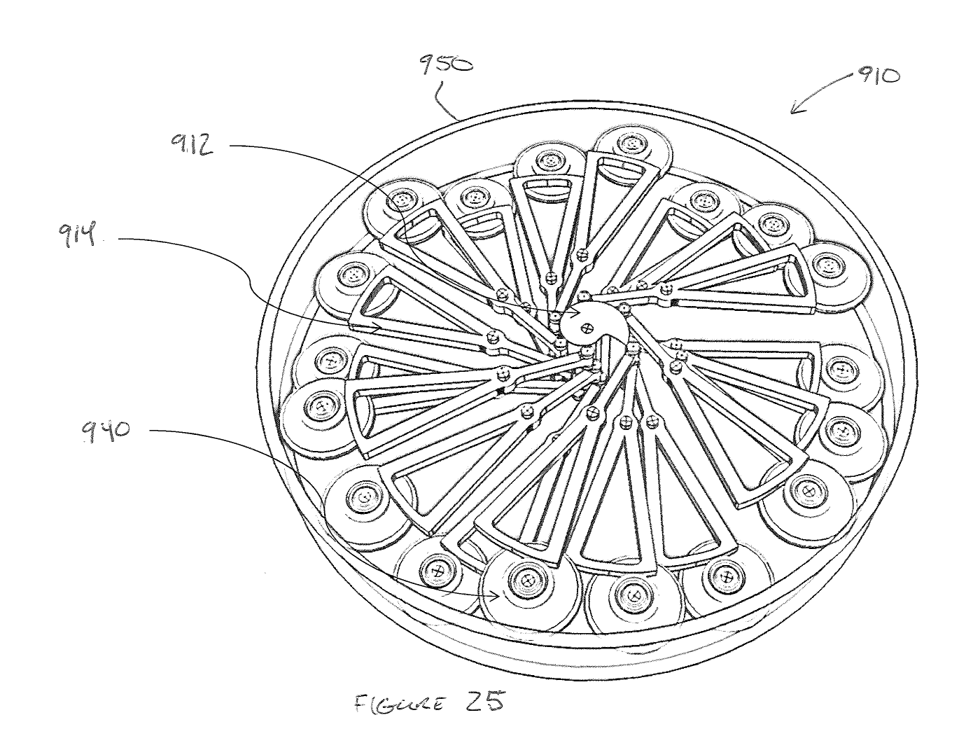

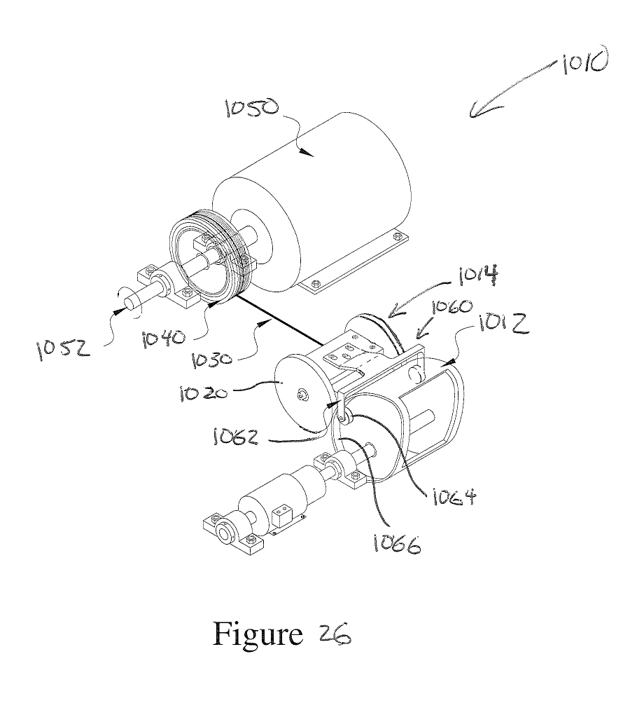

Referring to FIG. 26, illustrated therein is a torque converter 1010 including a rotor 1012, a cam follower 1014 magnetically attracted to the rotor 1012, and a coupling mechanism 1060 for positioning the cam follower 1014 adjacent to the rotor 1012. As shown, the coupling mechanism 1060 may include a carrier 1062 attached to the cam follower 1014, and one or more rollers 1064 mounted to the carrier 1062. The rollers 1064 are configured to roll along an inner lip 1066 of the rotor 1012. The cam follower 1014 may also include wheels 1020 that roll along an outer bearing surface of the rotor 1012. This configuration may help synchronize movement between the rotor 1012 and the cam follower 1014. For example, the coupling mechanism 1060 may help maintain magnetic field orientation between the rotor 1012 and cam follower 1014. In some examples, the coupling mechanism 1060 may help keep the cam follower 1014 in contact with the rotor 1012.

The torque converter 1010 also includes a flexible connection member 1030 between the cam follower 1014 and an output mechanism such as a generator 1050 and/or an output shaft 1052. The flexible connection member 1030 may be a cable, chain or other tensile member. The flexible connection member 1030 may be coiled around a clutch 1040, which may engage the output shaft 1052 in one rotational direction (i.e. during the power output phase), and disengage the output shaft 1052 in an opposite rotational direction (i.e. during the reset phase).

In this embodiment, a magnetic attractive force between the rotor 1012 and the cam follower 1014 produces tension and pulls the flexible connection member 1030 during the power output phase. The tension is transferred through the clutch 1040 to transmit torque and power to the output shaft 1052 and/or electric generator 1050. During the reset phase, the coupling mechanism 1060 keeps the cam follower 1014 against the rotor 1012 even though there might be slack in the flexible connection member 1030. A spring in the clutch 1040 may take up slack in the flexible connection member 1030 prior to the next cycle.

Referring to FIG. 27, illustrated therein is a torque converter 1110 including a rotor 1112, a cam follower 1114 magnetically attracted to the rotor 1112, and a coupling mechanism 1160 for positioning the cam follower 1114 adjacent to the rotor 1112. The torque converter 1110 also includes a rigid connection member 1130 attached to the cam follower 1114 and an output mechanism such as a generator 1150 and/or an output shaft 1152. The rigid connection member 1130 may be a rod pivotally coupled to the cam follower 1114 at a first pivot point 1132, and a pivotally coupled to a clutch 1140 at a second pivot point 1134.

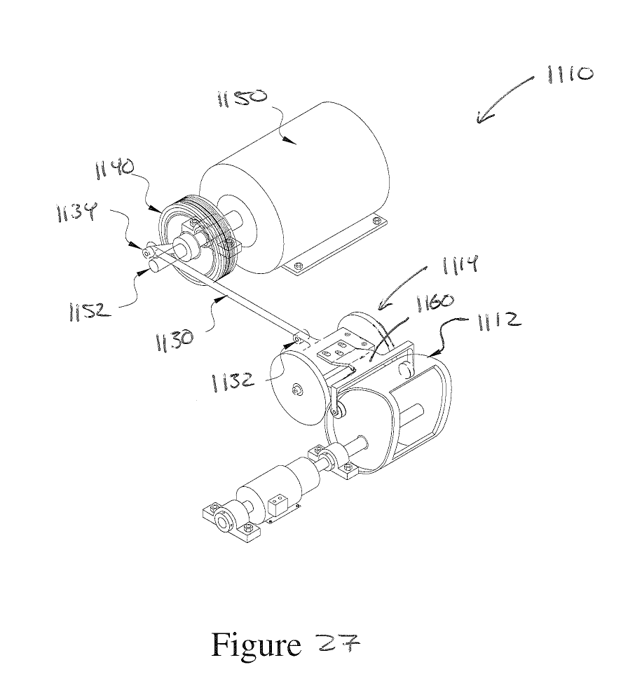

Referring to FIGS. 28 and 29, illustrated therein is a torque converter 1210 including a rotor 1212 rotated by a drive mechanism 1226, and a plurality of cam followers 1214 arranged around the rotor 1212. Each cam follower 1214 is magnetically attracted to the rotor 1212, and includes a coupling mechanism 1260 between the rotor 1212 and the cam follower 1214. Each cam follower 1214 is also pivotally coupled to a linear output mechanism such as a hydraulic cylinder 1250. The hydraulic cylinders 1250 are enclosed by an outer frame 1252 and are pivotally coupled thereto. As shown in FIG. 29, there may be a plurality of stacked sets of cam followers 1214 and hydraulic cylinders 1250 arranged vertically along the rotor 1212. In other embodiments, the hydraulic cylinders 1250 could be replaced by linear electric generators, or other linear output mechanisms.

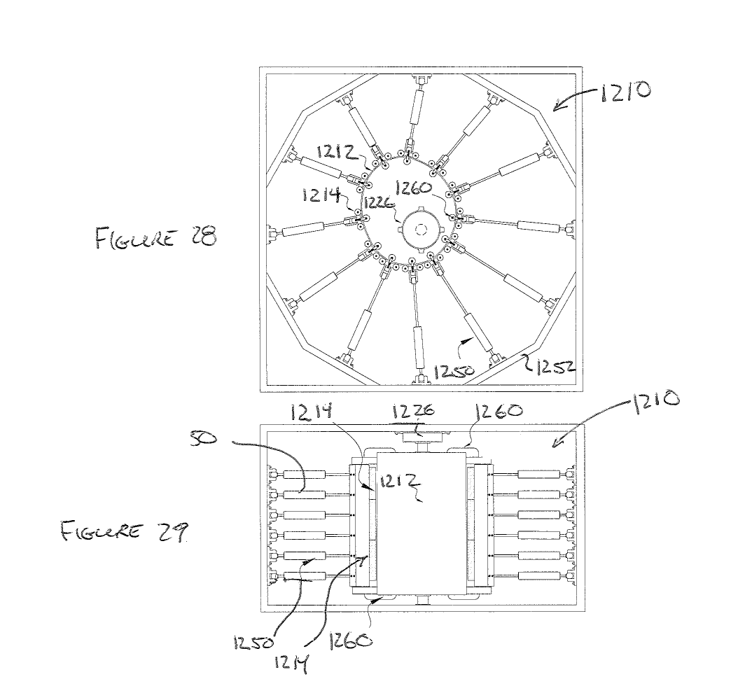

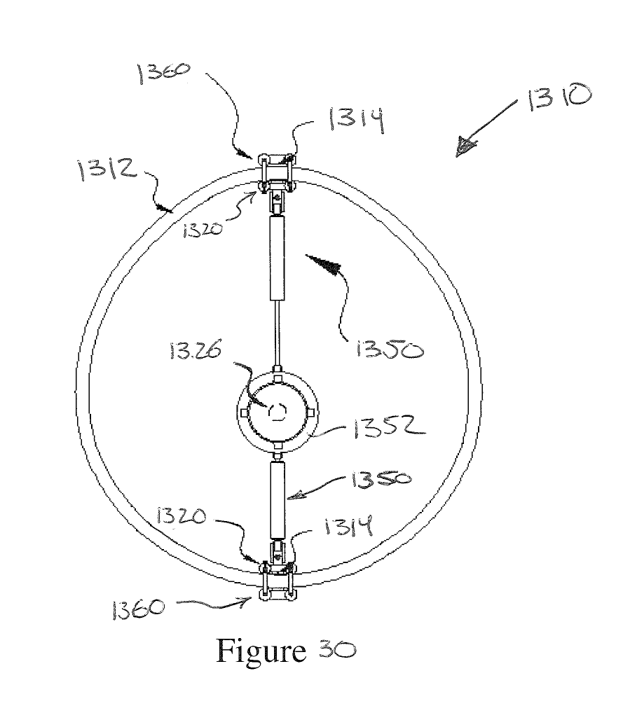

Referring to FIG. 30, illustrated therein is a torque converter 1310 including a rotor 1312, and one or more cam followers 1314 magnetically attracted to the rotor 1312. Each cam follower 1314 includes wheels 1320 and a coupling mechanism 1360 between the rotor 1312 and cam follower 1314. Furthermore, each cam follower 1314 is coupled to a linear output mechanism such as a hydraulic cylinder 1350. In this embodiment, the hydraulic cylinders 1350 are positioned radially inside the rotor 1312 and are pivotally coupled to an internal hub 1352. In operation, a drive mechanism 1326 rotates the rotor 1312, and the cam followers 1314 reciprocate to transmit output power to the hydraulic cylinders 1350. In other embodiments, the hydraulic cylinders 1350 could be replaced by linear electric generators, or other linear output mechanisms.

Referring to FIGS. 31 and 32, illustrated therein is a torque converter 1410 including a rotor 1412, and one or more cam followers 1414 magnetically attracted to the rotor 1412 (e.g. via follower magnets 1418). Each cam follower 1414 includes wheels 1420 and a coupling mechanism 1460 between the rotor 1412 and cam follower 1414. Furthermore, each cam follower 1414 is coupled to an inner hydraulic cylinder 1450A positioned radially inside the rotor 1412, and an outer hydraulic cylinder 1450B positioned radially outside the rotor 1412. The inner hydraulic cylinders 1450A are pivotally coupled to an internal hub 1452, and the outer hydraulic cylinders 1450B are pivotally coupled to an outer frame 1454. In operation, a drive mechanism 1426 rotates the rotor 1412 about a shaft 1424, and the cam followers 1414 transmit power to the hydraulic cylinders 1450A and 1450B. In other embodiments, the hydraulic cylinders 1450A, 1450B could be replaced by linear electric generators, or other linear output mechanisms.

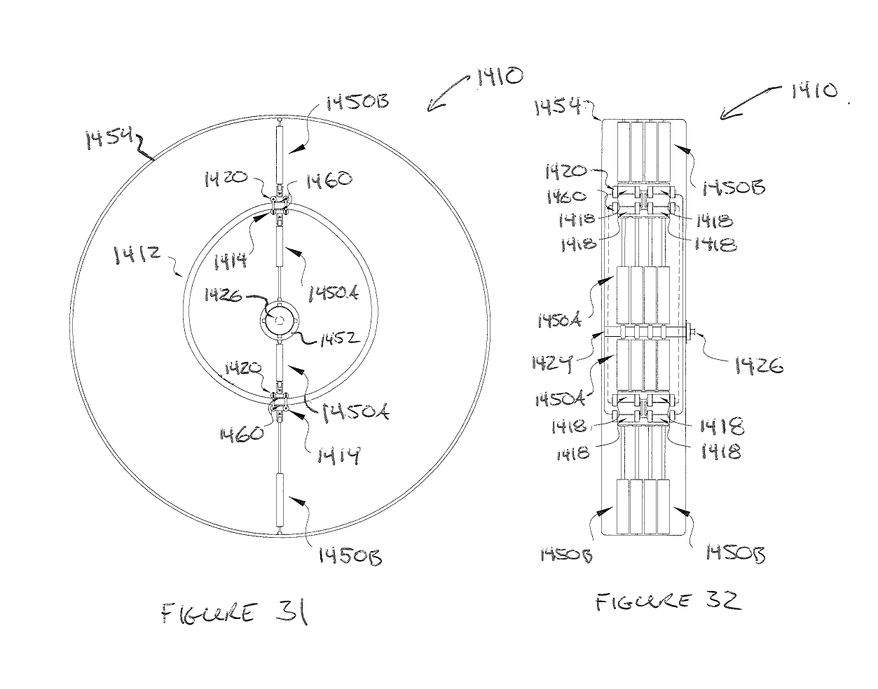

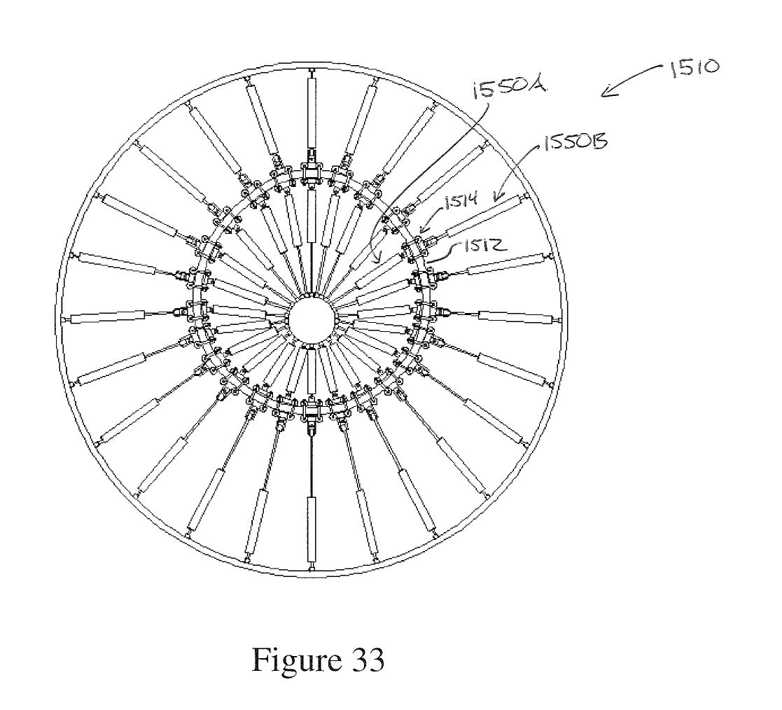

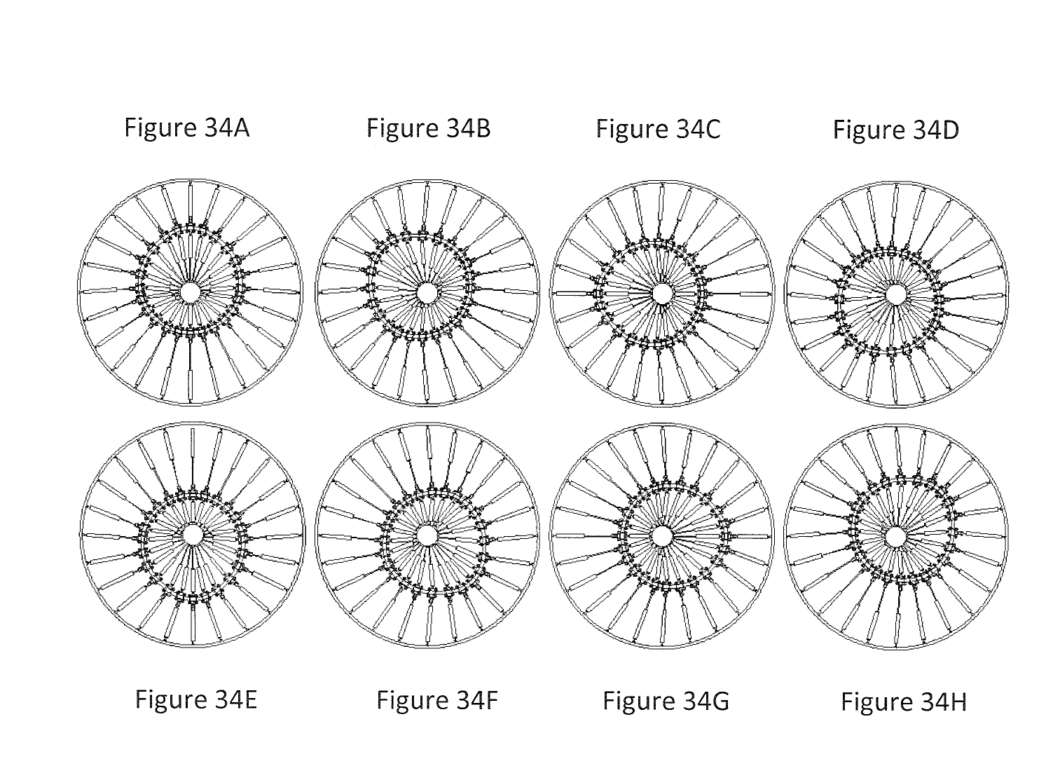

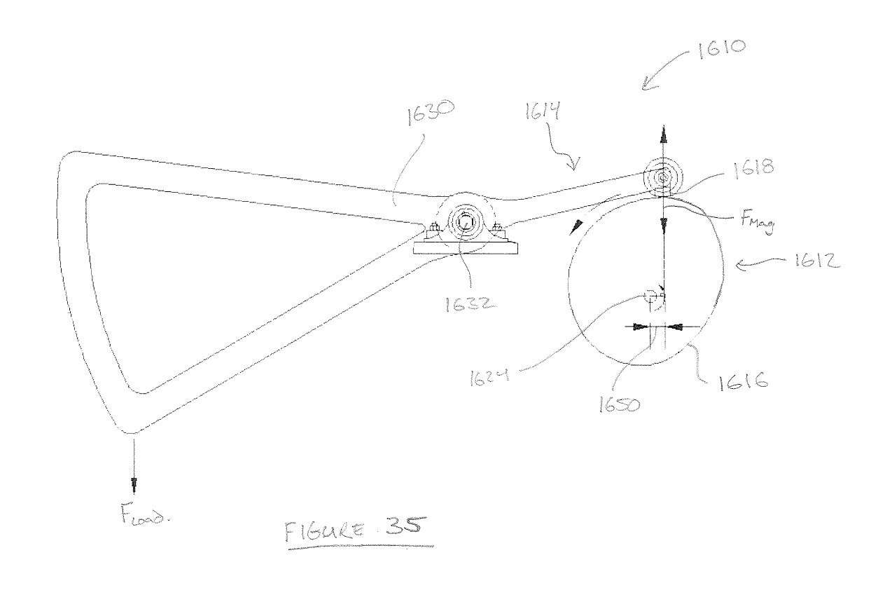

Referring to FIG. 33, illustrated therein is a torque converter 1510 similar to the torque converter 1410. In this embodiment, the torque converter 1510 includes a rotor 1512 with one or more cam followers 1514 and inner/outer hydraulic cylinders 1550A and 1550B arranged circumferentially along the rotor 1512. FIGS. 34A-34H illustrate one complete cycle of the torque converter 1510. In other embodiments, the hydraulic cylinders 1550A, 1550B could be replaced by linear electric generators, or other linear output mechanisms.

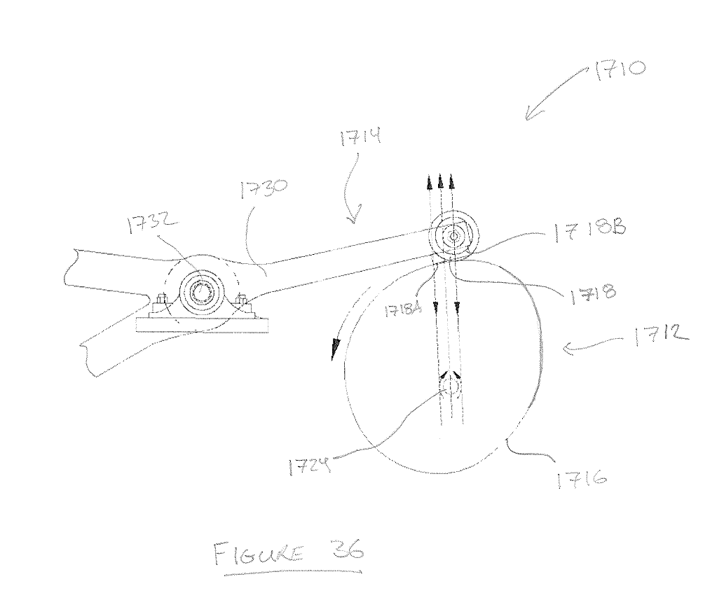

Referring now to FIG. 35, illustrated therein is a torque converter 1610 similar to the torque converter 510. The torque converter 1610 includes a rotor 1612 rotatable about an input shaft 1624, and a cam follower 1614 magnetically attracted to the rotor 1612. The rotor 1612 includes a magnetic rotor portion (e.g. a ferromagnetic drum 1616), and the cam follower 1614 includes a magnetic follower portion (e.g. a follower magnet 1618). The cam follower 1614 also includes a pivotal indexing arm 1630 that pivots about a pivot point 1632.

In use, the pivotal indexing arm 1630 may support an output load “F_{Load}”. The output load “F_{Load}” causes an output torque on the pivotal indexing arm 1630. To overcome the output torque, a corresponding input torque is applied to the rotor 1612. The input torque is proportional to a magnetic attractive force “F_{Mag}” between the follower magnet 1618 and the ferromagnetic drum 1616, and a moment arm 1650 associated with the magnetic attractive force “F_{Mag}”. When the follower magnet 1618 is parallel to the surface of the ferromagnetic drum 1616, the magnetic attractive force “F_{Mag}” acts approximately perpendicular to the ferromagnetic drum 1616. Furthermore, the eccentricity of the rotor 1612 means that the moment arm 1650 is offset from the input shaft 1624 during some portions of a rotational cycle.

In some cases, tilting the follower magnet 1618 relative to the ferromagnetic drum 1616 may alter the direction of the magnetic attractive force “F_{Mag}”, and result in a corresponding change in length of the moment arm 1650.

Referring now to FIG. 36, illustrated therein is a torque converter 1710 similar to the torque converter 1610. The torque converter 1710 includes a rotor 1712 rotatable about an input shaft 1724, and a cam follower 1714 magnetically attracted to the rotor 1712. The rotor 1712 includes a magnetic rotor portion (e.g. a ferromagnetic drum 1716), and the cam follower 1714 includes a magnetic follower portion (e.g. a follower magnet 1718). The cam follower 1714 also includes a pivotal indexing arm 1730 that pivots about a pivot point 1732.

In this embodiment, the follower magnet 1718 is tilted relative to the surface of the ferromagnetic drum 1716. Specifically, the follower magnet 1718 is tilted backward such that a leading edge 1718A of the follower magnet 1718 is closer to the ferromagnetic drum 1716 than a trailing edge 1718B of the follower magnet 1718. It is believed that tilting the follower magnet 1718 backward in this fashion can generate a counter-torque acting on the rotor 1712, and the counter-torque may reduce or offset an input torque normally associated with operating the rotor 1712 and the cam follower 1714.

Some of the torque converters described herein may operate based on a power generating cycle that uses magnetic attraction in order to output power. Some embodiments may develop torque over time to output power. Some embodiments may output electric, mechanical and/or hydraulic power, individually or simultaneously.

In some embodiments, output power may be supplied as electricity to an electrical supply grid. The electricity may be output with a frequency and voltage selected to match the electrical supply grid. Accordingly, the torque converter may be tied to the electrical supply grid.

In some embodiments, electricity may be supplied as a stand-alone system such as an AC or DC electrical generating system. Such systems may be suitable for emergency or ongoing electrical needs. For example, some embodiments may supply power for homes, industrial facilities, cell phones, laptops, heating systems, appliances, transportation vehicles and other large, medium, small, or miniature applications.

Some embodiments herein may provide an easily accessible and robust power generating system that can be installed and used in a variety of locations. Such systems may cost less than current technologies.

Some embodiments may provide a stand-alone or modular power generation systems capable of being easily shipped, assembled, and used throughout the world.

Some embodiments may increase power output and/or reduce space requirements.

While the above description provides examples of one or more apparatus, methods, or systems, it will be appreciated that other apparatus, methods, or systems may be within the scope of the claims as interpreted by one of skill in the art.

1. A torque converter comprising:
a) a rotor having an eccentric profile defining a power output phase and a reset phase, the rotor including a magnetic rotor portion;
b) a cam follower including a magnetic follower portion attracted to the magnetic rotor portion for biasing the cam follower towards the rotor, the cam follower being configured to reciprocate in response to rotation of the rotor through the power output phase and the reset phase; and
c) an output mechanism that is selectively engaged with the cam follower during the power output phase and disengaged from the cam follower during the reset phase.

2. The torque converter of claim 1, further comprising a spacer for separating the magnetic rotor portion from the magnetic follower portion.

3. The torque converter of claim 2, wherein the spacer includes a wheel coupled to the cam follower for rolling along the eccentric profile of the rotor.

4. The torque converter of claim 3, wherein the cam follower includes a linear indexer having a first end portion coupled to the wheel, and a geared rack movable along a longitudinal axis.

5. The torque converter of claim 3, wherein the cam follower includes a pivotal indexing arm having a first end portion coupled to the wheel, a second end portion having a drive gear, and a pivot point between the first end portion and the second end portion.

6. The torque converter of claim 1, wherein the eccentric profile of the rotor has a decreasing radius during the power output phase, and an increasing radius during the reset phase.

7. The torque converter of claim 6, wherein the radius of the rotor decreases in a linear manner throughout the power output phase.

8. The torque converter of claim 6, wherein the magnetic rotor portion includes a ferromagnetic drum, and the magnetic follower portion includes at least one follower magnet.

9. The torque converter of claim 1, wherein the magnetic rotor portion is positioned along the rotor for the power output phase, and wherein a reset section is positioned along the rotor for the reset phase.

10. The torque converter of claim 9, wherein the magnetic follower portion includes a follower magnet, and wherein the reset section of the rotor has a hollow opening.

11. The torque converter of claim 9, wherein the magnetic follower portion includes a follower magnet, and wherein the reset section of the rotor includes a non-ferromagnetic material.

12. The torque converter of claim 9, wherein the magnetic follower portion includes a follower magnet, and wherein the reset section of the rotor includes a reset magnet with opposite polarity to the follower magnet.

13. The torque converter of claim 1, further comprising:
a) an input shaft coupled to the rotor for receiving an input torque; and
b) a drive mechanism coupled to the input shaft.

14. The torque converter of claim 1, wherein the output mechanism includes a clutch.

15. The torque converter of claim 14, wherein the clutch includes a clutch bearing that engages a clutch shaft when rotated in one direction and disengages the clutch shaft when rotated in the opposite direction.

16. The torque converter of claim 15, wherein the output mechanism includes at least one of:
a) an output shaft coupled to the clutch shaft; and
b) a generator coupled to the clutch shaft.

17. The torque converter of claim 15, wherein the output mechanism includes a flywheel coupled to the clutch shaft.

18. The torque converter of claim 1, further comprising a reset assist mechanism for biasing the rotor toward a starting position during the reset phase.

19. The torque converter of claim 1, wherein the output mechanism includes a linear output mechanism.

20. The torque converter of claim 1, wherein the output mechanism includes a piezoelectric material.

21. A method of converting torque, the method comprising:
a) rotating a rotor having an eccentric profile defining a power output phase and a reset phase, the rotor including a magnetic rotor portion;
b) reciprocating a cam follower in response to rotation of the rotor, the cam follower including a magnetic follower portion attracted to the magnetic rotor portion for biasing the cam follower towards the rotor; and
c) selectively engaging an output mechanism with the cam follower during the power output phase, and disengaging the output mechanism from the cam follower during the reset phase.

22. The method of claim 21, wherein the magnetic rotor portion is separated from the magnetic cam portion by a spacer.
